(19) United States
(12) Patent Application Publication
(10) Pub. No.: US 2018/0244239 A1
(43) Pub. Date: Aug. 30, 2018

(54) AFTERMARKET VEHICLE ENTRY SYSTEM AND RELATED METHOD

(71) Applicant: FORD GLOBAL TECHNOLOGIES, LLC, Dearborn, MI (US)

(72) Inventors: John Robert Van Wiemeersch, Novi, MI (US); Howard Paul Tsvi Linden, Southfield, MI (US); Laura Viviana Hazebrouck, Birmingham, MI (US); Onoyom Essien Ekanem, White Lake, MI (US); Jevon Xiao, Palo Alto, CA (US)

(21) Appl. No.: 15/441,290

(22) Filed: Feb. 24, 2017

(51) Int. Cl. B60R 25/24; B60R 25/23; B60R 16/02; B60R 25/40; B60R 25/01

(52) U.S. Cl. CPC B60R 25/24; B60R 25/23; B60R 25/01; B60R 25/403; B60R 16/0207

(57) ABSTRACT

A system for allowing an operator to control one or more locks of a vehicle associated with a controller for controlling the one or more vehicle locks is provided. The system comprises a touchpad for mounting to the vehicle, the touchpad adapted for receiving a code from the operator for controlling the one or more locks. A generator is also provided for generating power for operating the touchpad based on kinetic energy associated with the vehicle. A wireless transceiver associated with the touchpad may transmit a signal to the controller when the code is provided to the touch pad. A second or alternative generator for generating power for operating the touchpad based on solar energy. A related method is also disclosed.

### TECHNICAL FIELD

This document relates generally to the motor vehicle field and, more particularly, to an aftermarket vehicle entry system.

### BACKGROUND

Often, it is desirable to enter a vehicle in a keyless manner without using a remote control, such as a key fob. In the past, vehicles have been equipped with integrated keypads in the door that allow for entry of a numerical code to unlock the doors and gain access to the vehicle. However, if a vehicle is sold without such a keypad, the user is unable to achieve keyless access.

A past proposal for such a system is found in U.S. Pat. No. 6,031,465, the disclosure of which is incorporated by reference. This system relies on power generated by a solar cell. As can be appreciated, this makes the keyless entry system unusable when there is insufficient power generated as a result of a lack of sunlight, which can make operation unreliable and possibly prevent access to the vehicle.

Accordingly, a need is identified for a vehicle entry system that can be implemented on vehicles that are manufactured without an integrated keypad, and which is powered as a result of kinetic energy associated with the vehicle.

### SUMMARY

In accordance with the purposes and benefits described herein, a system for allowing an operator to control one or more locks of a vehicle associated with a controller for controlling the one or more vehicle locks is provided. The system comprises a touchpad for mounting to the vehicle (such as to a door or adjacent window) and adapted for receiving a code from the operator for controlling the one or more locks. The system further includes a generator for generating power for operating the touchpad based on kinetic energy associated with the vehicle.

In one embodiment, a wireless transmitter is associated with the touchpad. The transmitter is for wireles sly transmitting a signal to the controller when the code is provided (which code may cause the controller to actuate vehicle locks associated with a plurality of vehicle closures). The touchpad may comprise a keypad, such as a numeric keypad, a capacitive touch keypad, an illuminated keypad, a fingerprint scanner, or any combination of the foregoing.

A battery may be provided for powering the touchpad, the wireless transmitter, or both. The generator may comprise a microgenerator for generating power for being stored by the battery. The vehicle may include a door wire harness, and the system may further include a connector for connecting the touchpad to the door wire harness.

The wireless transmitter may comprise an ultrahigh frequency transmitter. A receiver may be provided for receiving the code as a wireless signal. The touchpad may comprise an elongated, thin substrate adapted for connecting to a vehicle door. A remote control (such as a key fob) may also be provided for controlling the controller.

A further aspect of the disclosure pertains to a system for use in controlling vehicle access. The system comprises a vehicle including a lock for controlling access to the vehicle. A controller is associated with the vehicle lock, and a touchpad is provided for receiving a code for controlling the controller to wirelessly actuate the vehicle lock. A wireless transmitter is also provided for transmitting a signal to the controller when the code is provided to the touchpad. A generator associated with the system generates power for operating the touchpad from kinetic energy, such as from movement of the vehicle.

In one embodiment, the touchpad is selected from the group comprising a numeric keypad, a capacitive touch keypad, an illuminated keypad, a fingerprint scanner, or any combination of the foregoing (which may be mounted to a door of the vehicle). A battery may also be provided for powering the wireless transmitter, the battery connected to the generator. The vehicle may include a door wire harness, and the system may further including a connector for connecting the touchpad to the door wire harness. A receiver may be provided for receiving the code as a wireless signal.

Still a further aspect of the disclosure pertains to a method for allowing an operator to control one or more vehicle locks associated with a controller on a vehicle for wirelessly controlling the one or more vehicle locks using a touchpad associated with the vehicle for receiving a code from the operator for controlling the one or more vehicle locks. The method comprises providing power for the touchpad via a kinetic energy generator. The method may further comprise transmitting a signal from the touchpad when the code is provided, such as by wireless communication.

### BRIEF DESCRIPTION OF THE DRAWING FIGURES

The accompanying drawing figures incorporated herein and forming a part of the specification, illustrate several aspects of an aftermarket vehicle entry system and, together with the description, serve to explain certain principles thereof. In the drawing figures:

FIG. 1 is a perspective view of a vehicle including the aftermarket vehicle entry system according to the disclosure;

FIG. 2 is an enlarged cutaway front view of a keypad forming part of the system;

FIG. 3 is an enlarged cutaway rear view of the keypad; and

FIG. 4 is a schematic diagram illustrating the construction of the system according to one possible embodiment.

Reference will now be made in detail to the present preferred embodiments of an aftermarket vehicle entry system, examples of which are illustrated in the accompanying drawing figures.

### DETAILED DESCRIPTION

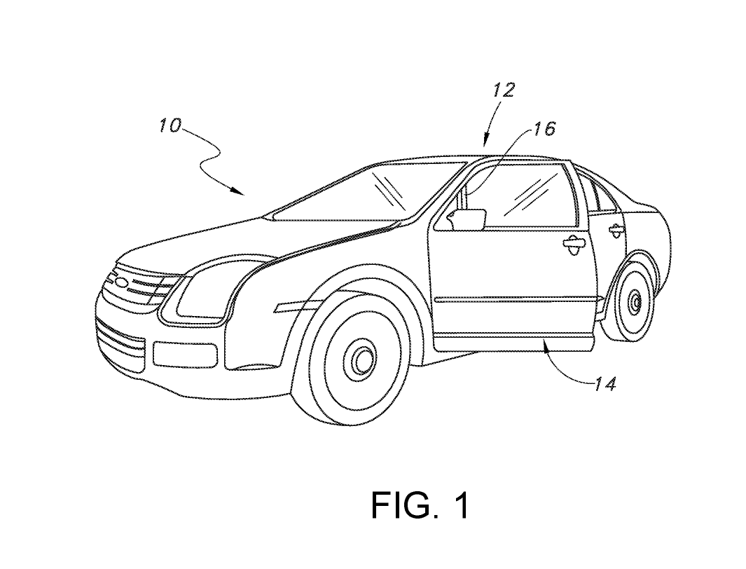

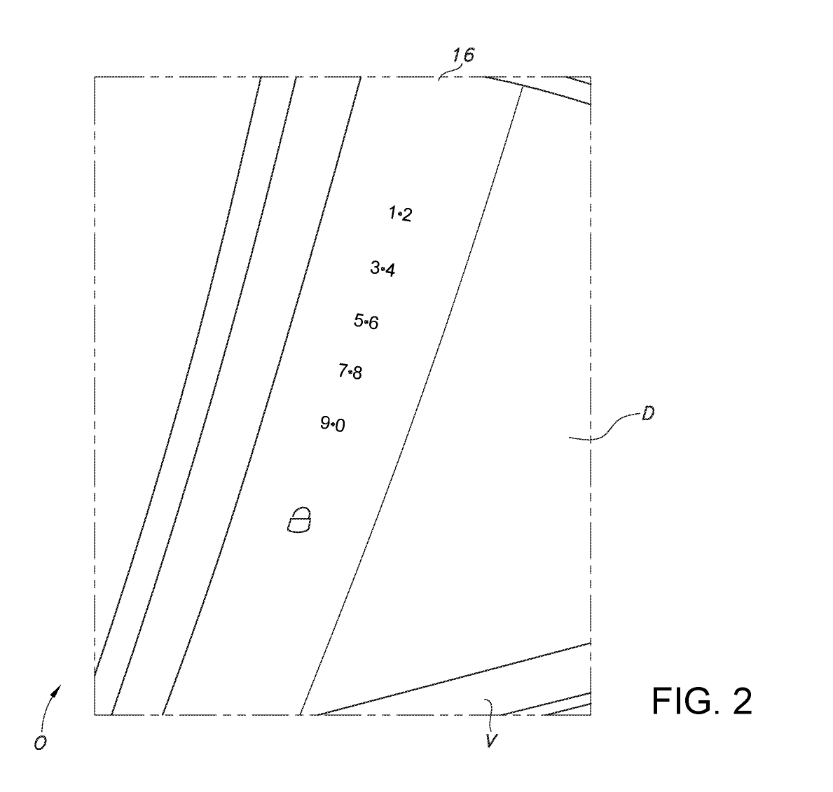

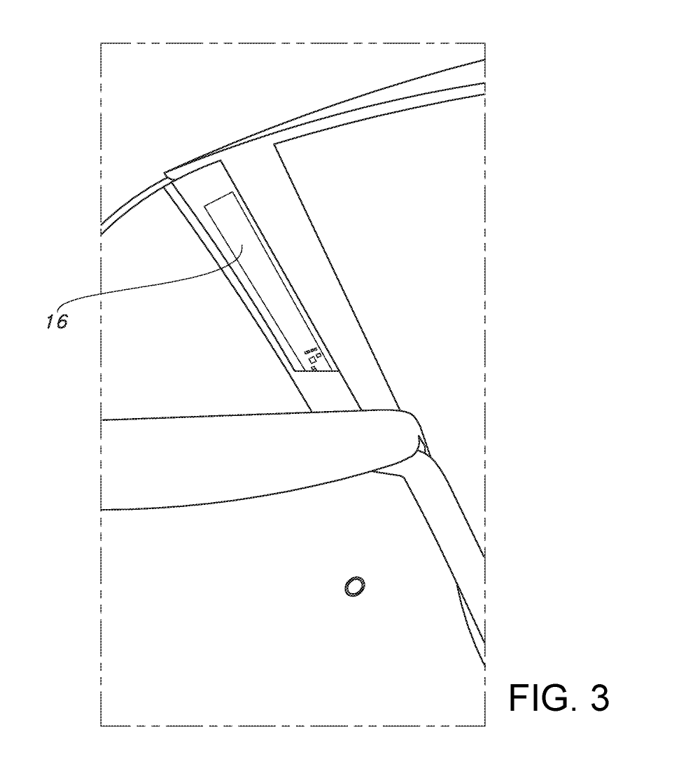

With reference now to FIG. 1, a vehicle 10 is shown with an aftermarket vehicle entry system 12 for locking the vehicle or providing access to the vehicle by unlocking a door 14, trunk, or like closure that were collectively or independently locked for preventing unwanted access to the vehicle and thereby assisting in securing it and its contents against theft. From FIG. 2, it can be understood that the system 12 may include a touchpad 16 for mounting to the vehicle, such as in an aftermarket fashion (that is, once the vehicle has been manufactured and sold to a dealer or the end user). In the illustrated embodiment, the touchpad 16 comprises an elongated, thin substrate that may be mounted directly to the vehicle door 14, such as along the window portion thereof, using suitable fasteners, such as adhesives or mechanical connectors (which may be provided as part of a kit with the touchpad 16). However, as shown in FIGS. 2 (outside view) and 3 (inside view), the touchpad 16 may be mounted other than on or adjacent to the door, such as on a rear window D of the vehicle adjacent to the door opening 0 as shown in FIG. 3 or it may also be mounted in other locations accessible from the vehicle exterior (but not necessarily exposed to the exterior of the vehicle; i.e., the touchpad may be covered by a transparent cover).

In the illustrated embodiment, the touchpad 16 comprises a keypad adapted for entering a code formed of numbers, which may be pre-determined or operator selected. The touchpad 16 may be a capacitive touch keypad, such that the operator may input the code by touching the keypad itself (note illuminated touch areas 1-2, 3-4, 5-6, 7-8, 9-10 in FIG. 2, and also the lock icon that can be used to signal that entry of the code is complete). To facilitate use at night, the keypad may be illuminated, such as by internal LEDs (see, e.g., U.S. Pat. No. 8,400,265, the disclosure of which is incorporated herein by reference). Instead of a numerical code, the keypad may also be adapted for scanning a fingerprint of the operator as the code, and thereby aid in determining whether vehicle access should be granted or what level of vehicle access should be granted (ex., trunk only, not cabin access).

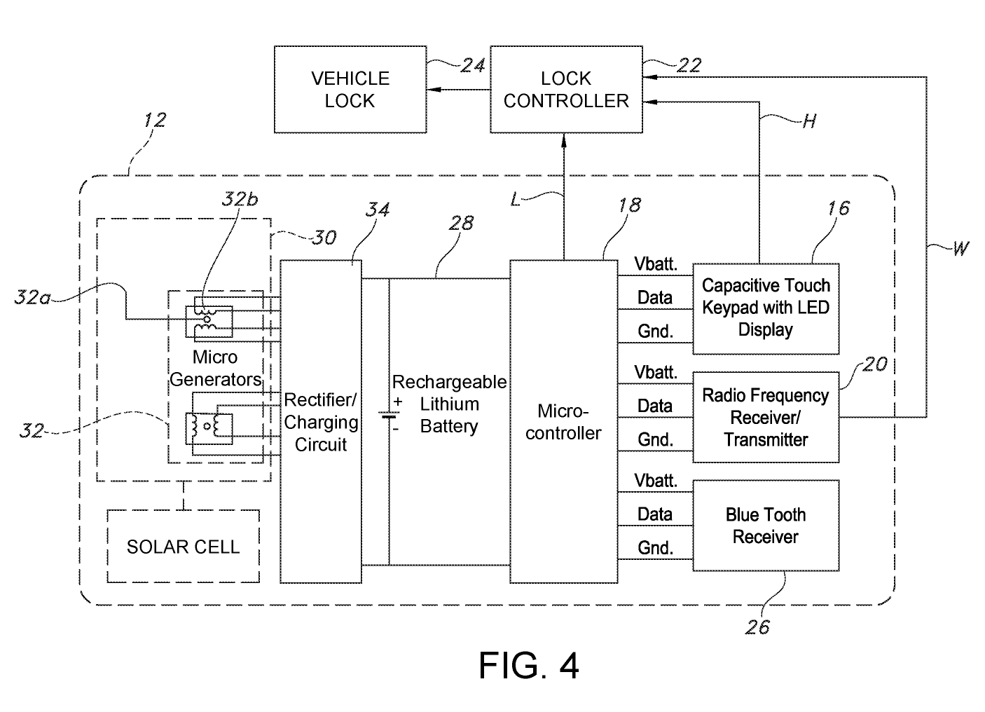

With reference to the control diagram of FIG. 4, it can be understood that the code may be transmitted from the touchpad 16 to a controller 18 forming part of the system 12. The controller 18 may be associated with an ultrahigh frequency (UHF) transceiver 20 for receiving a signal and wireles sly transmitting the signal (as indicated by line W) to a lock controller 22 associated with the vehicle 10 to control the state of the vehicle lock 24. Thus, when the operator enters the correct code, as determined by the controller 18, the lock controller 22 causes the vehicle lock 24 to unlock the closure, such as door 14, and thereby grant access to the vehicle.

As one alternative, the touchpad 16 may be adapted for a hard-wire connection directly to the lock controller 22, as indicated by line H. This may be achieved by providing the touchpad 16 with a connector, such as a pigtail, for connecting directly to a wiring harness associated with the vehicle 10, such as within the door 14. In this manner, the inputting of the code to the touchpad 16 may be transmitted directly to the lock controller 22 in a non-wireless manner, as indicated by line L in FIG. 4.

As yet another alternative, the system 12 may include a further transceiver 26 for receiving a code for unlocking the vehicle 10 from a remote control. For instance, the transceiver 26 may comprise a BLUETOOTH transceiver for connecting and communicating with a BLUETOOTH transceiver on the vehicle 10 or a “smart” phone or like mobile computer for transmitting the code to the controller 18. The system 12 may use BLUETOOTH Class or BLUETOOTH Low Energy (BLE). The controller 18 may then deliver the code to the lock controller 22 in the above-described manner to grant access to the vehicle.

Power for powering the system 12 may be provided by way of a battery 28, which may be connected directly to the touchpad 16 and form part of a common housing for the system. This avoids the need for connecting the system 12 to the vehicle battery or like remote power supply (but as noted above, this can be done via the door wiring harness, if desired). The battery 28 associated with the system 12 may be of the rechargeable lithium type.

When independent of the vehicle power system, power may be supplied from a power source 30 associated with the system. In the illustrated embodiment, this source 30 comprises a self-contained generator, such as a kinetic power generator, for generating power based on kinetic energy, such as the result from movement of the vehicle. In one embodiment, the kinetic power generator comprises one or more microgenerators 32. The microgenerators 32 may be of the type using a micromagnet 32a and coil 32b (see, e.g., U.S. Patent Application Publication No. 2010/0187835, the disclosure of which is incorporated herein by reference), which as a result of movement of all or part of the vehicle 10 may generate and supply an alternating current to a rectifier associated with a charging circuit 34 for delivering direct current for charging the battery 28. For variants of the wireless keypad that use the micro-generators 32, the keypad 16 may be a mechanical variant rather than a capacitive one, since the capacitive technology requires a steady quiescent current whereas mechanical keypads can be used to wake the keypad circuitry.

Additionally, the power source 30 may include an alternate source of power to charge the battery 28 or otherwise supply power to the keypad 16 when the level of kinetic energy is insufficient. For instance, the power source 30 may further comprise a solar cell for generating power based on solar energy.

Entry of the code may cause the controller 18 to signal the lock controller 22 to actuate vehicle locks associated with a plurality of vehicle closures. For example, the code may cause one or more doors to unlock. Alternatively or additionally, code entry may cause the vehicle trunk lid or hatch to unlock. The touchpad 16 may also be adapted to select which closures are unlocked by entering the code, such as by for example including separate indicia or icons for the doors or trunk.

In summary, an aftermarket vehicle entry system 12 is provided for allowing a purchaser of a vehicle 10 lacking a touchpad 16 to be accommodated to include one. The touchpad 16 may comprise a thin elongated substrate for mounting to the vehicle 10, such as on or adjacent to the door 14. Entry of a code for unlocking the vehicle door 14 or other closure may be transmitted to the vehicle lock controller 22, either via a wired or wireless connection, which then actuates the vehicle lock 24. The system 12 may include a battery 28 powered by an associated power source 30 that may convert kinetic energy for storage to allow for operation independent of the vehicle power system or any other external source, and thereby allow for easy retrofit onto existing vehicles. The system 12 may also be adapted to work with an existing remote control, such as a mobile computer or smart phone, to receive the code for unlocking the vehicle closure.

The foregoing description has been presented for purposes of illustration. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A system for allowing an operator to control one or more locks of a vehicle associated with a controller for controlling the one or more vehicle locks, comprising:
a touchpad for mounting to the vehicle, the touchpad adapted for receiving a code from the operator for controlling the one or more locks; and
a generator for generating power for operating the touchpad based on kinetic energy associated with the vehicle.

2. The system of claim 1, further including a wireless transceiver associated with the touchpad for transmitting a signal to the controller when the code is provided to the touchpad.

3. The system of claim 2, wherein the touchpad comprises a keypad.

4. The system of claim 3, wherein the keypad is selected from the group comprising a numeric keypad, a capacitive touch keypad, an illuminated keypad, a fingerprint scanner, or any combination of the foregoing.

5. The system of claim 2, further including a battery for powering the touchpad, the wireless transmitter, or both.

6. The system of claim 5, wherein the generator comprises a microgenerator for generating power for being stored by the battery.

7. The system of claim 1, wherein the vehicle includes a door wire harness, and further including a connector for connecting the touchpad to the door wire harness.

8. The system of claim 1, wherein the wireless transmitter comprises an ultrahigh frequency transceiver.

9. The system of claim 1, further including a receiver for receiving the code as a wireless signal.

10. The system of claim 1, wherein the touchpad comprises an elongated, thin substrate adapted for connecting to a vehicle door or other exterior surface.

11. The system of claim 1, further including a remote control for controlling the controller.

12. The system of claim 1, wherein entry of the code causes the controller to actuate vehicle locks associated with a plurality of vehicle closures.

13. The system of claim 1, further including a secondary generator for generating power for operating the touchpad.

14. A system for use in controlling vehicle access, comprising:
a vehicle including a lock for controlling access to the vehicle;
a controller associated with the vehicle lock;
a touchpad for receiving a code for controlling the controller to wirelessly actuate the vehicle lock;
a wireless transceiver for transmitting a signal to the controller when the code is provided to the touchpad; and
a first generator for generating power for operating the touchpad from kinetic energy.

15. The system of claim 14, wherein the touchpad is selected from the group comprising a numeric keypad, a capacitive touch keypad, an illuminated keypad, a fingerprint scanner, or any combination of the foregoing.

16. The system of claim 14, further including a battery for powering the wireless transceiver, the battery connected to the generator.

17. The system of claim 14, wherein the vehicle includes a door wire harness, and further including a connector for connecting the touchpad to the door wire harness.

18. The system of claim 14, further including a receiver for receiving the code as a wireless signal.

19. The system of claim 14, further including a second generator for generating power for operating the touchpad based on solar energy.

20. A method for allowing an operator to control one or more vehicle locks associated with a controller on a vehicle for wireles sly controlling the one or more vehicle locks using a touchpad associated with the vehicle for receiving a code from the operator for controlling the one or more vehicle locks, comprising:
providing power for the touchpad, including via a kinetic energy generator; and
wirelessly transmitting a signal from the touchpad when the code is provided; and
locking or unlocking the one or more vehicle locks.
